(19) United States
(12) Patent Application Publication
(10) Pub. No.: US 2026/0253379 A1
(43) Pub. Date: Aug. 27, 2026

(54) IMAGE RETRIEVAL SYSTEM

(71) Applicant: Smiths Detection France S.A.S., Vitry Sur Seine (FR)

(72) Inventors: Olivier RISSER-MAROIX, Vitry-sur-Seine (FR); Najib GADI, Vitry-sur-Seine (FR); Camille KURTZ, Vitry-sur-Seine (FR); Nicolas LOMENIE, Vitry-sur-Seine (FR)

(21) Appl. No.: 18/577,530

(22) PCT Filed: Jun. 30, 2022
(86) PCT No.: PCT/GB2022/051686

§ 371 Date: Jan. 8, 2024

(30) Foreign Application Priority Data
Jul. 9, 2021 (GB) 2109943.7

(51) Int. Cl. G06V 10/764; G06F 16/2457; G06F 16/532; G06N 3/0475; G06N 3/08; G06V 10/74; G06V 10/774; G06V 10/82

(52) U.S. Cl. CPC G06V 10/764; G06F 16/24578; G06F 16/532; G06N 3/0475; G06N 3/08; G06V 10/761; G06V 10/774; G06V 10/82; G06V 2201/05

(57) ABSTRACT

A computer-implemented method for generating an image retrieval system configured to select a plurality of relevant images of items from a plurality of datasets of images, in response to a query corresponding to an image of cargo generated using penetrating radiation, the plurality of relevant images of items being selected based on visual similarity with the query, is provided. The method includes obtaining a plurality of visually-associated training images of items from a plurality of datasets of images, the plurality of visually-associated training images being associated with each other based on visual similarity, the visual similarity association using input by a user, each of the training images being associated with an annotation indicating the dataset of images to which the training image belongings, and training the image retrieval system by applying a deep learning algorithm to the obtained visually-associated training images.

### CROSS-REFERENCE TO RELATED APPLICATIONS

The present application is a national stage entry of PCT/GB2022/051686 filed on Jun. 30, 2022, which claims the benefit of GB Patent Application No. 2109943.7 filed on Jul. 9, 2021, the contents of which are hereby incorporated by reference in their entirety.

### BACKGROUND

The disclosure relates but is not limited to generating an image retrieval system configured to select a plurality of relevant images of items from a plurality of datasets of images, in response to a query corresponding to an image of cargo generated using penetrating radiation. The disclosure also relates but is not limited to retrieving content-based images. The disclosure also relates but is not limited to producing a device configured to retrieve content-based images. The disclosure also relates but is not limited to corresponding devices and computer programs or computer program products.

Inspection images of containers containing cargo may be generated using penetrating radiation. In some examples, a user may want to detect objects corresponding to a cargo of interest on the inspection images. Detection of such objects may be difficult. In some cases, the object may not be detected at all. In cases where the detection is not clear from the inspection images, the user may inspect the container manually, which may be time consuming for the user.

### BRIEF DESCRIPTION

Aspects and embodiments of the disclosure are set out in the appended claims. These and other aspects and embodiments of the disclosure are also described herein.

Any feature in one aspect of the disclosure may be applied to other aspects of the disclosure, in any appropriate combination. In particular, method aspects may be applied to device and computer program aspects, and vice versa.

Furthermore, features implemented in hardware may generally be implemented in software, and vice versa. Any reference to software and hardware features herein should be construed accordingly.

### BRIEF DESCRIPTION OF THE DRAWINGS

Embodiments of the present disclosure will now be described, by way of example, with reference to the accompanying drawings, in which:

FIG. 1 shows a flow chart illustrating an example method according to the disclosure;

FIG. 2 schematically illustrates an example system and an example device configured to implement the example method of FIG. 1;

FIG. 3 illustrates an example inspection image according to the disclosure;

FIG. 4A shows a flow chart illustrating a detail of the example method of FIG. 1;

FIG. 4B shows a flow chart illustrating a detail of the example method of FIG. 4A;

FIG. 4C schematically illustrates an example of random cargo training images displayed to the user on a man/machine interface;

FIG. 5 shows a flow chart illustrating another example method according to the disclosure; and

FIG. 6 shows a flow chart illustrating another example method according to the disclosure.

In the figures, similar elements bear identical numerical references.

### DETAILED DESCRIPTION

### Overview

The disclosure discloses an example method for generating an image retrieval system configured to select a plurality of relevant images of items from a plurality of datasets of images. The selection is performed in response to a query corresponding to an image of cargo generated using penetrating radiation (e.g. X-rays, but other penetrating radiation is envisaged).

In the method of the disclosure, the plurality of relevant images of items are selected based on visual similarity with the query.

The image retrieval system of the disclosure allows to retrieve the visually relevant images corresponding to the visual query, efficiently, from the plurality of, potentially large, datasets of images.

The image retrieval system of the disclosure is different from an image retrieval system based on a semantic similarity with a query.

A conventional image retrieval system based on the semantic similarity with the query uses a dataset of semantically labelled images. The semantic similarity is not ambiguous. However, limitations of retrieving semantically similar images include that, if the system initially wrongly classified the query image, the retrieved images will be in fact unrelated to the query image. This could lead an operator of the system to wrongly classify the query image as different from the retrieved images.

The image retrieval system of the disclosure is based on an assumption that a human operator categorizes objects by recalling a plurality of examples representative of the objects. Therefore, to classify a new visual query, the human operator will compare the visual query with memories of a plurality of examples. For instance, when a human operator from a customs organisation has to decide, from a scanned image of cargo of interest, whether the cargo is legitimate or not, it is assumed that the operator will compare the image of the cargo with a plurality of examples of images they remember from past experiences. However, since scanned images of cargo are not natural images and therefore less memorable than natural images, remembering scanned images of cargo may be difficult for a human operator and may thus lead to wrong classification decisions.

The image retrieval system of the disclosure retrieves a plurality of most visually similar images from a plurality of datasets of images-e.g. from a plurality of different classes of items- and assists the human operator to make a right classification decision for the scanned image of the cargo of interest. Retrieving the most similar images from a plurality of different datasets of images, e.g. classes of different items, enhances the accuracy of the decision of the human operator, compared to making a classification decision based on semantically related images or on no images at all.

In some examples, the total number of datasets in the plurality of datasets is between 50 and 250, for example the total number of datasets may substantially be equal to 100 datasets, as a non-limiting example. It should be understood that each dataset corresponds to a class of items or a type of items or a family of items. In some examples, each of the dataset corresponds to a class of the Harmonised Commodity Description and Coding System, HS, the HS including hierarchical sections and chapters corresponding to types of items. Alternatively or additionally, in some examples, such as when the HS-codes are not available or when there are multiples HS-codes for the images, the datasets may be created by using other methods, such as clustering of the images (using methods such as KMeans, Affinity Propagation, Spectral Clustering, Hierarchical Clustering, etc.). For example, one dataset may correspond to images of a class of food items (such as fruits, or coffee beans), one dataset may correspond to images of a class of drugs, etc. Alternatively or additionally, one dataset may correspond to images of a class of fruits, one dataset may correspond to images of another class of fruits, etc. The differences between the datasets may depend on a level of desired granularity between the datasets.

The image retrieval system may enable an operator of an inspection system to benefit from an existing plurality of datasets of images and/or existing textual information (such as expert reports) and/or codes associated with the images. The image retrieval system may enable enhanced inspection of cargo of interest.

The image retrieval system may enable the operator of the inspection system to benefit from automatic outputting of textual information (such as cargo description reports, scanning process reports) and/or codes associated with associated with the cargo of interest.

The image retrieval system of the disclosure may enable novice operators to take advantage of the expertise of their experienced colleagues to interpret the content of the scanned image by automatically proposing them the interpretation verdicts of their expert colleagues, via the annotations. The image retrieval system of the disclosure may automatically generate text reports describing the loading content from the image, the scanning process context and the reports approved formerly by the expert operators.

The disclosure also discloses an example method for retrieving content-based images. The disclosure also discloses an example method for producing a device configured to retrieve content-based images. The disclosure also discloses corresponding devices and computer programs or computer program products.

### Detailed Description of Example Embodiments

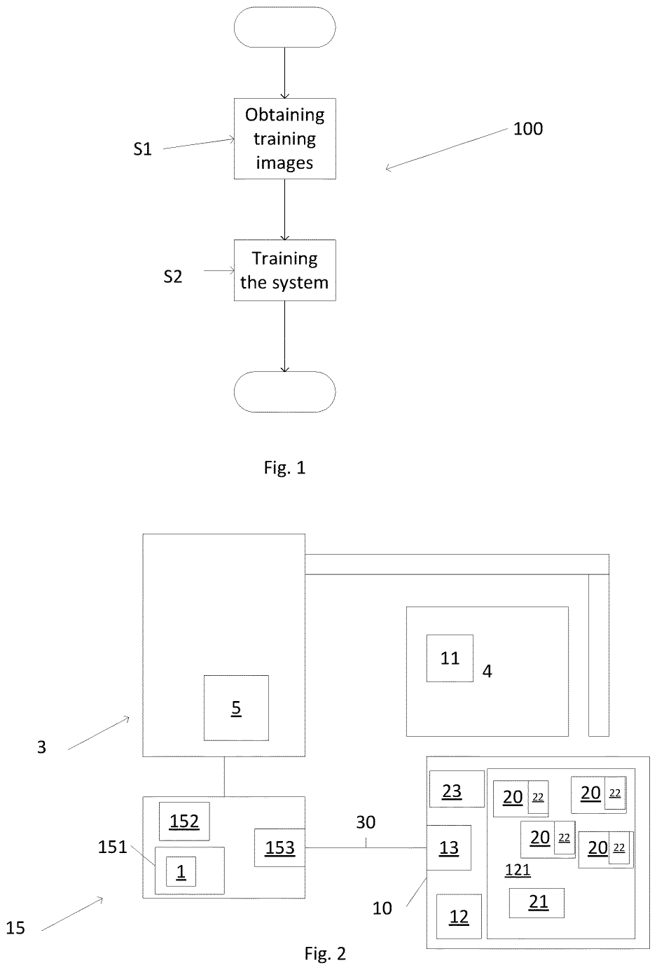

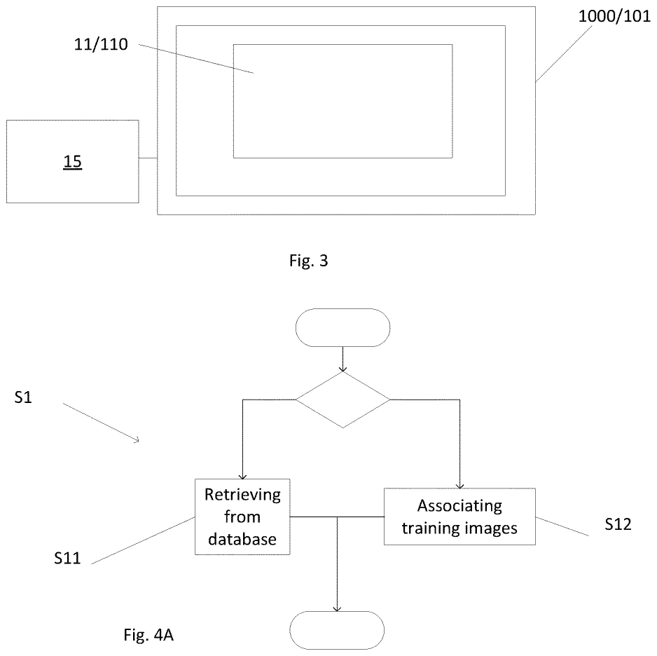

FIG. 1 shows a flow chart illustrating an example method 100 according to the disclosure for generating an image retrieval system 1 illustrated in FIG. 2. FIG. 2 shows a device 15 configurable by the method 100 to select a plurality of images 22 from a plurality of datasets 20 of images, in response to a query corresponding to an inspection image 1000 (shown in FIG. 3), the inspection image 1000 including cargo 11 of interest generated using penetrating radiation. The cargo 11 of interest may be any type of cargo, such as food, industrial products, drugs or cigarettes, as non-limiting examples.

The inspection image 1000 may be generated using penetrating radiation, e.g. by the device 15.

The method 100 of FIG. 1 includes in overview:
obtaining, at S1, a plurality of visually-associated training images 101 (shown in FIG. 3) of items; and
training, at S2, the image retrieval system 1 by applying a deep learning algorithm to the obtained visually-associated training images 101.

The plurality of visually-associated training images 101 may be taken from the plurality of datasets 20 of images.

As explained in greater detail later, the plurality of visually-associated training images 101 may be associated with each other based on visual similarity, the visual similarity association using input by a user.

To enhance the training, each of the training images 101 may be associated with an annotation indicating the dataset 20 of images to which the training image belongs.

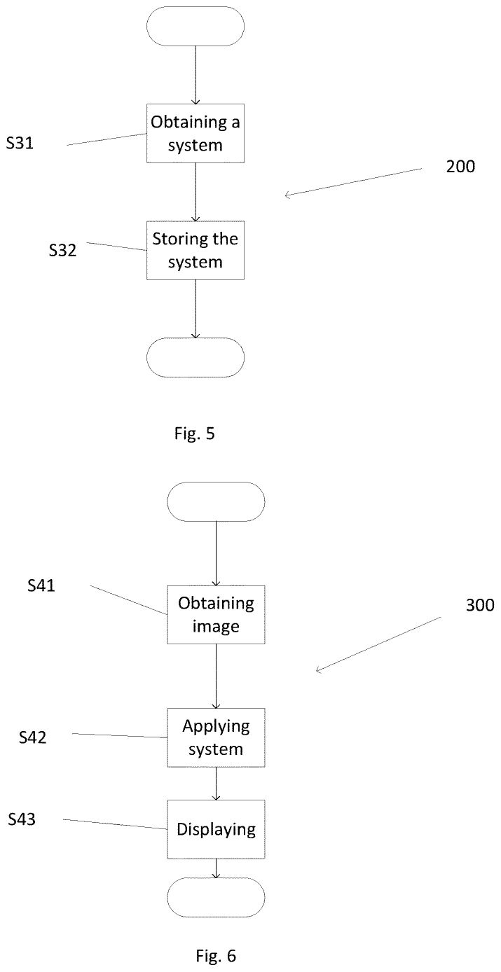

As described in more detail later, in reference to FIG. 5 showing a method 200, configuration of the device 15 involves storing, e.g. at S32, the image retrieval system 1 at the device 15. In some examples, the image retrieval system 1 may be obtained at S31 (e.g. by generating the image retrieval system 1 as in the method 100 of FIG. 1). In some examples, obtaining the image retrieval system 1 at S31 may include receiving the image retrieval system 1 from another data source.

As described above, the image retrieval system 1 is derived from the training images 101 using the deep learning algorithm, and is arranged to produce an output corresponding to the cargo 11 of interest in the inspection image 1000. In some examples and as described in more detail below, the output may correspond to selecting a plurality of images 22 of items from the plurality of datasets 20 of images. Each of the dataset 20 may include at least one of: one or more training images 101 and a plurality of inspection images 1000.

The image retrieval system 1 is arranged to produce the output more easily, after it is stored in a memory 151 of the device 15 (as shown in FIG. 2), even though the process 100 for deriving the image retrieval system 1 from the training images 101 may be computationally intensive.

After it is configured, the device 15 may provide an accurate output of a plurality of visually similar images of items corresponding to the cargo 11, by applying the image retrieval system 1 to the inspection image 1000. The selecting process is illustrated (as process 300) in FIG. 6 (described later).

### Computer System and Detection Device

FIG. 2 schematically illustrates an example computer system 10 and the device 15 configured to implement, at least partly, the example method 100 of FIG. 1. In particular, in one embodiment, the computer system 10 executes the deep learning algorithm to generate the image retrieval system 1 to be stored on the device 15. Although a single device 15 is shown for clarity, the computer system 10 may communicate and interact with multiple such devices.

The training images 101 may themselves be obtained using images acquired using the device 15 and/or using other, similar devices and/or using other sensors and data sources. In some examples, the training images 101 may have been obtained in a different environment, e.g. using a similar device (or equivalent set of sensors) installed in a different (but potentially similar) environment, or in a controlled test configuration in a laboratory environment.

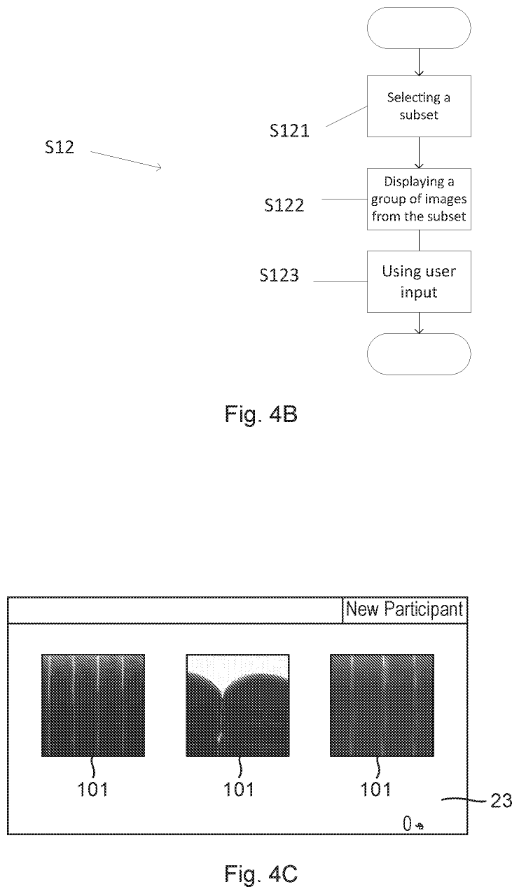

In some examples, as illustrated in FIG. 4A, obtaining at S1 the visually-associated training images 101 may include retrieving at S11 the plurality of visually-associated training images 101 from an existing database of images (such as the plurality of datasets 20, in a non-limiting example), after the visual similarity association using the input by the user. In a non-limiting example, the plurality of datasets 20 may form an index of X-ray cargo images which have been previously visually-associated by the user, e.g. the user may include one or more human operators of a customs organisation.

Alternatively or additionally, obtaining at S1 the training images 101 may include associating at S12 the plurality of training images 101 of items using the input by the user, e.g. the one or more human operators of a customs organisation as a non-limiting example.

The associating at S12 is described later.

The computer system 10 of FIG. 2 includes a memory 121, a processor 12 and a communications interface 13.

The system 10 may be configured to communicate with one or more devices 15, via the interface 13 and a link 30 (e.g. Wi-Fi connectivity, but other types of connectivity may be envisaged).

The memory 121 is configured to store, at least partly, data, for example for use by the processor 12. In some examples the data stored on the memory 121 may include the plurality of datasets 20 and/or data such as the training images 101 (and the data used to generate the training images 101) and/or the deep learning algorithm.

In some examples, the processor 12 of the system 10 may be configured to perform, at least partly, at least some of the steps of the method 100 of FIG. 1 and/or the method 200 of FIG. 5 and/or the method 300 of FIG. 6.

The detection device 15 of FIG. 2 includes a memory 151, a processor 152 and a communications interface 153 (e.g. Wi-Fi connectivity, but other types of connectivity may be envisaged) allowing connection to the interface 13 via the link 30.

In a non-limiting example, the device 15 may also include an apparatus 3 acting as an inspection system, as described in greater detail later. The apparatus 3 may be integrated into the device 15 or connected to other parts of the device 15 by wired or wireless connection.

In some examples, as illustrated in FIG. 2, the disclosure may be applied for inspection of a real container 4 containing the cargo 11 of interest. Alternatively or additionally, at least some of the methods of the disclosure may include obtaining the inspection image 1000 by irradiating, using penetrating radiation, one or more real containers 4 configured to contain cargo, and detecting radiation from the irradiated one or more real containers 4.

In other words, the apparatus 3 may be used to acquire the plurality of training images 101 and/or to acquire the inspection image 1000.

In some examples, the processor 152 of the device 15 may be configured to perform, at least partly, at least some of the steps of the method 100 of FIG. 1 and/or the method 200 of FIG. 5 and/or the method 300 of FIG. 6.

### Generating the Image Retrieval System

Referring back to FIG. 1, the image retrieval system 1 is built by applying a deep learning algorithm to the training images 101. Any suitable deep learning algorithm may be used for building the image retrieval system 1. For example, approaches based on convolutional deep learning algorithm may be used.

The image retrieval system 1 is generated based on the training images 101 obtained at S1.

The learning process is typically computationally intensive and may involve large volumes of training images 101 (such as several thousands or tens of thousands of images). In some examples, the processor 12 of the system 10 may include greater computational power and memory resources than the processor 152 of the device 15. The image retrieval system 1 generation is therefore performed, at least partly, remotely from the device 15, at the computer system 10. In some examples, at least steps S1 and/or S2 of the method 100 are performed by the processor 12 of the computer system 10. However, if sufficient processing power is available locally then the image retrieval system 1 learning could be performed (at least partly) by the processor 152 of the device 15.

The deep learning step involves inferring image features, such as the visual similarity, based on the training images 101 and encoding the detected features in the form of the image retrieval system 1.

To learn the visual similarity between images the deep learning step may involve a convolutional neural network, CNN, learning from the visual association of the training images 101 using the input by the user (e.g. corresponding to a behavioural experiment on the user).

As illustrated in FIG. 4B, in some examples, the associating at S12 may include iteratively performing, a given number of times, the following steps:
selecting, at S121, a subset of the plurality of datasets 20 of images, each dataset in the selected subset being different from another dataset 20 in the subset; and
displaying, at $122, a group of training images 101 to the user, the group including at least one image from each dataset 20 in the selected subset.

The step S122 uses a man/machine interface 23 (illustrated at FIG. 2), such as including a display, and input means such as a keyboard and/or a mouse and/or a tactile function of the display.

In some examples, selecting at S121 the subset of the plurality of datasets 20 of images includes randomly selecting a number of datasets in the plurality of datasets 20, the number in the subset being smaller than a total number of datasets in the plurality of datasets.

As already stated, the total number of datasets 20 may be between 50 and 250. In some examples, the number of datasets selected at S121 in the subset may be between 2 and 20, for instance between 3 and 10 as a non-limiting example. For example, the subset may include 5 datasets among 100 datasets in the plurality of datasets 20. In a non-limiting example, at S122 a group of 5 training images 101 (i.e. one image from each dataset 20 in the selected subset) may be displayed to the user.

The input at S123 by the user also uses the man/machine interface 23.

The input at S123 by the user, used for the associating at S12, may result from the user marking at least one training image 101 in the displayed group of images, the marked at least one training image being the least visually similar to the other training images in the displayed group of training images. For example, in the group of displayed 5 training images, the user will mark (i.e. eliminate) the training image being the least visually similar to the other training images. In other words, the input from the user may result in eliminating the visually “oddest” training image in the displayed group, such that the remaining (i.e. unmarked) training images in the displayed group are considered visually similar to each other.

In the example illustrated in FIG. 4C, as a result of S121 and S122, 3 random cargo training images 101 are displayed to the user on the man/machine interface 23. The user is requested to mark, using the man/machine interface 23, the image they think to be the “one-odd-out” such that the two remaining images are visually more similar to each other than with the marked image. From the input on the man/machine interface (e.g. the collected marking clicks), the deep learning step can learn a model able to predict the user's input, i.e. the visual similarity between images.

Alternatively or additionally, the input by the user, used for the associating at S12, may result from the user ranking a subgroup of the training images in the displayed group of training images 101, based on their visual similarity with a training image considered as a query. For example, in the group of displayed 5 training images, one image may be considered as a query, and the user may rank the subgroup of 4 training images based on the query.

In some examples, ranking the subgroup may include ordering the images in the subgroup, in visual similarity increasing or decreasing order. In some examples the ordering may include the user actually displacing the images of the subgroup to place them in the visual similarity increasing or decreasing order. Alternatively or additionally, ranking the subgroup may include ranking the images in the subgroup, in visual similarity increasing or decreasing order. In some examples the ranking of the images may include assigning a note (e.g. between 1 and 4 in a subgroup of 4 images, with 1 being the most visually similar to the query and 4 being the least visually similar to the query). Alternatively or additionally, ranking the subgroup may include numerically grading the images in the subgroup. In some examples the grading of the images may include the user giving a grade (e.g. between 1 and 5, 1 corresponding to “not at all visually similar” and 5 corresponding to “very visually similar”, as a non-limiting example) to the images of the subgroup.

The given number of times for the iterative classification may be high and may involve the same user performing the association a high number of times and/or different users performing the association.

The training images 101 are annotated, and each of the training images 101 is associated with an annotation indicating the dataset of images (e.g. a label or a class of the HS) to which the training image belongs. In other words, in the training images 101, the nature of the item 110 in the image is known. In some examples, a domain specialist may manually annotate the training images 101 with ground truth annotation (e.g. the type of the item for the image). The retrieval system 1 may use the annotation of the images in the plurality of datasets (e.g. index) to filter and retrieve only the first more similar images per dataset (e.g. label).

In some examples the annotation may include a code of the Harmonised Commodity Description and Coding System, HS, the HS including hierarchical sections and chapters corresponding to the type of the item represented in the training image. Alternatively or additionally, the annotation may include textual information corresponding to the type of item represented in the training image. In some examples, the textual information may include at least one of: a report describing the item and a report describing parameters of an inspection of the item, e.g. by an inspection system (such as radiation dose, radiation energy, inspection device type, etc.).

Once trained, the model is used as a visual similarity measure between images. The learned similarity function may be used to retrieve images (e.g. cargo images) that human operators (e.g. operators in customs organisations) are likely to find similar to a new inspection image, i.e. a query image. The retrieval system 1 will retrieve a plurality of images from the plurality of datasets 20 (e.g. index) which have a visually similar content.

In the disclosure, the similarity function between the images may be based on a vector signature of the images. The signature of an image can be represented by a set of features or a real-valued vector obtained from hand-crafted feature extractor or a deep-learning based feature extractor such as Visual Geometry Group (VGG) or ResNet architectures, as non-limiting examples. During the training performed at S2, the image retrieval system 1 is configured to learn, so that the vector signature captures the visual similarity between features of the images.

As also described in greater detail below and shown in FIG. 2, the features of the images may be derived from one or more compact vectorial representations 21 of the images (images such as the training images 101 and/or the inspection image 1000). In some examples, the one or more compact vectorial representations of the images may include at least one of a feature vector f, a matrix V of descriptors and a final image representation, FIR. In some examples, the one or more compact vectorial representations 21 of the images may be stored in the memory 121 of the system 10.

Other architectures are also envisaged for the image retrieval system 1. For example, deeper architectures may be envisaged and/or an architecture of the same shape as the architecture described above that would generate vectors or matrices (such as the vector f, the matrix V, and/or the final image representation FIR) with sizes different from those already discussed may be envisaged.

### Device Manufacture

As illustrated in FIG. 5, the method 200 of producing the device 15 configured to retrieve a plurality of content-based images from a plurality of datasets of images, may include:
obtaining, at S31, an image retrieval system 1 generated by the method 100 according to any aspects of the disclosure; and
storing, at S32, the obtained image retrieval system 1 in the memory 151 of the device 15.

The image retrieval system 1 may be stored, at S32, in the detection device 15. The image retrieval system 1 may be created and stored using any suitable representation, for example as a data description including data elements specifying selecting conditions and their selecting outputs (e.g. a selecting based on a distance of image features with respect to image features of the query). Such a data description could be encoded e.g. using XML or using a bespoke binary representation. The data description is then interpreted by the processor 152 running on the device 15 when applying the image retrieval system 1.

Alternatively, the deep learning algorithm may generate the image retrieval system 1 directly as executable code (e.g. machine code, virtual machine byte code or interpretable script). This may be in the form of a code routine that the device 15 can invoke to apply the image retrieval system 1.

Regardless of the representation of the image retrieval system 1, the image retrieval system 1 effectively defines a ranking algorithm (including a set of rules) based on input data (i.e. the inspection image 1000 defining a query).

After the image retrieval system 1 is generated, the image retrieval system 1 is stored in the memory 151 of the device 15. The device 15 may be connected temporarily to the system 10 to transfer the generated image retrieval system (e.g. as a data file or executable code) or transfer may occur using a storage medium (e.g. memory card). In one approach, the image retrieval system is transferred to the device 15 from the system 10 over the network connection 30 (this could include transmission over the Internet from a central location of the system 10 to a local network where the device 15 is located). The image retrieval system 1 is then installed at the device 15. The image retrieval system could be installed as part of a firmware update of device software, or independently.

Installation of the image retrieval system 1 may be performed once (e.g. at time of manufacture or installation) or repeatedly (e.g. as a regular update). The latter approach can allow the classification performance of the image retrieval system to be improved over time, as new training images become available.

### Applying the Image Retrieval System to Perform Ranking

Retrieving of images from the plurality of datasets 20 is based on the image retrieval system 1.

After the device 15 has been configured with the image retrieval system 1, the device 15 can use the image retrieval system 1 based on locally acquired inspection images 1000 to select a plurality of images of items from the plurality of datasets 20 of images, by displaying a batch of relevant images of items from the plurality of relevant images of items selected.

In some examples, the image retrieval system 1 effectively defines a ranking algorithm for extracting features from the query (i.e. the inspection image 1000), computing a distance of the features of the plurality of images of the plurality of datasets 20 with respect to the image features of the query, and displaying a batch of relevant images of items from the plurality of relevant images of items selected based on the computed distance.

In general, the image retrieval system 1 is configured to extract the features of the cargo 11 of interest in the inspection image 1000 in a way similar to the features extraction performed during the training at S2.

FIG. 6 shows a flow chart illustrating an example method 300 for selecting a plurality of images of items from the plurality of datasets 20 of images. The method 300 is performed by the device 15 (as shown in FIG. 2).

The method 300 includes:
obtaining, at S41, the inspection image 1000;
applying, at S42, to a plurality of datasets of images, an image retrieval system generated by the method of any aspects of the disclosure, using the inspection image as the query; and
displaying, at S43, a batch of relevant images of items from the plurality of relevant images of items selected based on the applying.

It should be understood that in order to display at S43 the plurality of images in the plurality of datasets 20, the device 15 may be connected, at least temporarily, to the system 10, and the device 15 may access the memory 121 of the system 10.

In some examples, at least a part of the plurality of datasets 20 and/or a part of the one or more compact vectorial representations 21 of images (such as the feature vector f, the matrix V of descriptors and/or the final image representation, FIR) may be stored in the memory 151 of the device 15.

In some examples, displaying at S43 the batch of relevant images of items may include selecting a result number of relevant images to be displayed in the batch, each dataset in the displayed batch being different from another dataset. In some examples, the selected result number is between 2 and 20 relevant images, optionally between 3 and 10 relevant images.

In some examples, displaying the batch of relevant images of items may include filtering the selected relevant images of items to select the most visually similar image in each dataset of images, the filtering using an annotation associated with each relevant image of items and indicating the dataset of images to which the relevant image belongs.

In some examples, displaying the batch of relevant images of items may further include displaying an at least partial code of the Harmonised Commodity Description and Coding System, HS, the HS including hierarchical sections and chapters corresponding to a type of item represented in the relevant image. Alternatively or additionally, displaying the batch of relevant images of items may further include displaying at least partial textual information corresponding to a type of item represented in the relevant image, optionally wherein the textual information includes at least one of: a report describing the item and a report describing parameters of an inspection of the item.

### Further Details and Examples

The disclosure may be advantageous but is not limited to customs and/or security applications.

The disclosure typically applies to cargo inspection systems (e.g. sea or air cargo).

The apparatus 3 of FIG. 2, acting as an inspection system, is configured to inspect the container 4, e.g. by transmission of inspection radiation through the container 4.

The container 4 configured to contain the cargo may be, as a non-limiting example, placed on a vehicle. In some examples, the vehicle may include a trailer configured to carry the container 4.

The apparatus 3 of FIG. 2 may include a source 5 configured to generate the inspection radiation.

The radiation source 5 is configured to cause the inspection of the cargo through the material (usually steel) of walls of the container 4, e.g. for detection and/or identification of the cargo. Alternatively or additionally, a part of the inspection radiation may be transmitted through the container 4 (the material of the container 4 being thus transparent to the radiation), while another part of the radiation may, at least partly, be reflected by the container 4 (called “back scatter”) In some examples, the apparatus 3 may be mobile and may be transported from a location to another location (the apparatus 3 may include an automotive vehicle).

In the source 5, electrons are generally accelerated under a voltage between 100 keV and 15 MeV.

In mobile inspection systems, the power of the X-ray source 5 may be e.g., between 100 keV and 9.0 MeV, typically e.g., 300 keV, 2 MeV, 3.5 MeV, 4 MeV, or 6 MeV, for a steel penetration capacity e.g., between 40 mm to 400 mm, typically e.g., 300 mm (12 in).

In static inspection systems, the power of the X-ray source 5 may be e.g., between 1 MeV and 10 MeV, typically e.g., 9 MeV, for a steel penetration capacity e.g., between 300 mm to 450 mm, typically e.g., 410 mm (16.1 in).

In some examples, the source 5 may emit successive X-ray pulses. The pulses may be emitted at a given frequency, between 50 Hz and 1000 Hz, for example approximately 200 Hz.

According to some examples, detectors may be mounted on a gantry, as shown in FIG. 2. The gantry for example forms an inverted “L”. In mobile inspection systems, the gantry may include an electro-hydraulic boom which can operate in a retracted position in a transport mode (not shown on the Figures) and in an inspection position (FIG. 2). The boom may be operated by hydraulic actuators (such as hydraulic cylinders). In static inspection systems, the gantry may include a static structure.

It should be understood that the inspection radiation source may include sources of other penetrating radiation, such as, as non-limiting examples, sources of ionizing radiation, for example gamma rays or neutrons. The inspection radiation source may also include sources which are not adapted to be activated by a power supply, such as radioactive sources, such as using Co60 or Cs137. In some examples, the inspection system includes detectors, such as X-ray detectors, optional gamma and/or neutrons detectors, e.g., adapted to detect the presence of radioactive gamma and/or neutrons emitting materials within the cargo, e.g., simultaneously to the X-ray inspection. In some examples, detectors may be placed to receive the radiation reflected by the container 4.

In the context of the present disclosure, the container 4 may be any type of container, such as a holder or a box, etc. The container 4 may thus be, as non-limiting examples a palette (for example a palette of European standard, of US standard or of any other standard) and/or a train wagon and/or a tank and/or a boot of the vehicle and/or a “shipping container” (such as a tank or an ISO container or a non-ISO container or a Unit Load Device (ULD) container).

In some examples, one or more memory elements (e.g., the memory of one of the processors) can store data used for the operations described herein. This includes the memory element being able to store software, logic, code, or processor instructions that are executed to carry out the activities described in the disclosure.

A processor can execute any type of instructions associated with the data to achieve the operations detailed herein in the disclosure. In one example, the processor could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

As one possibility, there is provided a computer program, computer program product, or computer readable medium, including computer program instructions to cause a programmable computer to carry out any one or more of the methods described herein. In example implementations, at least some portions of the activities related to the processors may be implemented in software. It is appreciated that software components of the present disclosure may, if desired, be implemented in ROM (read only memory) form. The software components may, generally, be implemented in hardware, if desired, using conventional techniques.

Other variations and modifications of the system will be apparent to the skilled in the art in the context of the present disclosure, and various features described above may have advantages with or without other features described above. The above embodiments are to be understood as illustrative examples, and further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

1. A computer-implemented method for generating an image retrieval system configured to select a plurality of relevant images of items from a plurality of datasets of images, in response to a query corresponding to an image of cargo generated using penetrating radiation, the plurality of relevant images of items being selected based on visual similarity with the query, the method comprising:
obtaining a plurality of visually-associated training images of items from a plurality of datasets of images, the plurality of visually-associated training images being associated with each other based on visual similarity, the visual similarity association using input by a user, each of the training images being associated with an annotation indicating the dataset of images to which the training image belongs; and
training the image retrieval system by applying a deep learning algorithm to the obtained visually-associated training images.

2. The method of claim 1, wherein each dataset correspond to a respective class of items, or
wherein obtaining the visually-associated training images comprises at least one of:
retrieving the plurality of visually-associated training images of items from a database after the visual similarity association using the input by the user; and
associating the plurality of training images of items using the input by the user.

3. The method of claim 2, wherein associating the plurality of training images of items using the input by the user comprises iteratively performing, a given number of times, the following steps:
selecting a subset of the plurality of datasets of images, each dataset in the selected subset being different from another dataset in the subset;
displaying a group of training images to the user, the group comprising at least one image from each dataset in the selected subset; and
the input by the user results from the user performing at least one of:
marking at least one training image in the displayed group of images, the marked at least one training image being the least visually similar to the other training images in the displayed group of training images, and
ranking a subgroup of the training images in the displayed group of training images, based on their visual similarity with a training image considered as a query.

4. The method of claim 3, wherein ranking the subgroup comprises at least one of:
ordering the images in the subgroup, in visual similarity increasing or decreasing order,
ranking the images in the subgroup, in visual similarity increasing or decreasing order, and
numerically grading the images in the subgroup.

5. The method of claim 3, wherein selecting the subset of the plurality of datasets of images comprises randomly selecting a number of datasets in the plurality of datasets, the number being smaller than a total number of datasets in the plurality of datasets.

6. The method of claim 1, wherein the annotation comprises a code of the Harmonised Commodity Description and Coding System, HS, the HS comprising hierarchical sections and chapters corresponding to the type of the item represented in the training image.

7. The method of claim 1, wherein the annotation comprises textual information corresponding to the type of item represented in the training image.

8. The method of claim 1, wherein applying the deep learning algorithm generates a similarity function configured to retrieve images of items that a user is likely to find visually similar.

9. The method of claim 8, wherein the similarity function is based on a vector signature of the images.

10. The method of claim 1, performed at a computer system separate from a device configured to inspect cargo.

11. A computer-implemented method for retrieving content-based images, comprising:
obtaining an inspection image of cargo of interest generated using penetrating radiation;
applying, to a plurality of datasets of images, an image retrieval system generated by the method of claim 1, using the inspection image as the query; and
displaying a batch of relevant images of items from the plurality of relevant images of items selected based on the applying.

12. The method of claim 11, wherein displaying the batch of relevant images of items comprises selecting a result number of relevant images to be displayed in the batch, each dataset in the displayed batch being different from another dataset.

13. The method of claim 12, wherein the selected result number is between 2 and 20 relevant images.

14. The method of claim 11, wherein displaying the batch of relevant images of items comprises filtering the selected relevant images of items to select the most visually similar image in each dataset of images, the filtering using an annotation associated with each relevant image of items and indicating the dataset of images to which the relevant image belongs.

15. The method of claim 11, wherein displaying the batch of relevant images of items further comprises displaying an at least partial code of the Harmonised Commodity Description and Coding System, HS, the HS comprising hierarchical sections and chapters corresponding to a type of item represented in the relevant image.

16. The method of claim 11, wherein displaying the batch of relevant images of items further comprises displaying at least partial textual information corresponding to a type of item represented in the relevant image.

17. A method of producing a device configured to retrieve content-based images, the method comprising:
obtaining an image retrieval system generated by the method of claim 1; and
storing the obtained image retrieval system in a memory of the device.

18. A device configured to retrieve content-based images, the device comprising a memory storing an image retrieval system generated by the method of claim 1.

19. The device of claim 18, further comprising a processor, and wherein the memory of the device further comprises instructions which, when executed by the processor, enable the processor to perform the method.

20. A computer program or a computer program product comprising instructions which, when executed by a processor, enable the processor to perform the method of claim 1.
